(19) United States
(12) Patent Application Publication
(10) Pub. No.: US 2026/0048588 A1
(43) Pub. Date: Feb. 19, 2026

(54) Liquid Ejecting Head

(71) Applicant: SEIKO EPSON CORPORATION, Tokyo (JP)

(72) Inventors: Takanori AIMONO, Shiojiri (JP); Takahiro KATAKURA, Okaya (JP); Mitsuki EBISAWA, Shiojiri (JP)

(21) Appl. No.: 19/302,778

(22) Filed: Aug. 18, 2025

(30) Foreign Application Priority Data
Aug. 19, 2024 (JP) 2024-137640

(51) Int. Cl. B41J 2/14

(52) U.S. Cl. CPC B41J 2/1433; B41J 2/14233; B41J 2002/14306; B41J 2002/14475

(57) ABSTRACT

When a direction in which the flow path substrate and the nozzle substrate are stacked is defined as a first direction, and a direction orthogonal to the first direction is defined as a second direction, the nozzle includes a first nozzle portion passing from the first surface to a connection position in the nozzle substrate and a second nozzle portion that is a hole passing from the connection position to the second surface, the first nozzle portion has a constant width in the second direction regardless of a position in the first direction, and the second nozzle portion has a width in the second direction that gradually increases such that an amount of increase in width in the second direction decreases as a position in the first direction approaches the second surface.

The present application is based on, and claims priority from JP Application Serial Number 2024-137640, filed Aug. 19, 2024, the disclosure of which is hereby incorporated by reference herein in its entirety.

### BACKGROUND

### 1. Technical Field

The present disclosure relates to a liquid ejecting head.

### 2. Related Art

In the related art, a liquid ejecting head that ejects a liquid such as ink from a nozzle provided in a nozzle substrate has been disclosed. For example, JP-A-2021-011032 discloses a nozzle having a first nozzle portion and a second nozzle portion disposed next to each other in a plate thickness direction of a nozzle substrate. The first nozzle portion is provided in a liquid ejecting direction with respect to the second nozzle portion and is provided, over the plate thickness direction, in the same shape as an opening provided on a surface of the nozzle substrate in the ejecting direction. The second nozzle portion has an inner surface linearly inclined with respect to the plate thickness direction.

However, in the nozzle of the related art described above, there is a case where a liquid surface of the nozzle is broken and a bubble is mixed into the nozzle.

### SUMMARY

A liquid ejecting head according to a preferred aspect of the present disclosure includes a flow path substrate provided with a flow path, a nozzle substrate provided with a nozzle causing the flow path to communicate with an outside and passing through the nozzle substrate from a first surface to a second surface of the nozzle substrate, the second surface being bonded to the flow path substrate, and an energy generation element that generates energy for ejecting a liquid from the nozzle, and when a direction in which the flow path substrate and the nozzle substrate are stacked is defined as a first direction, and a direction orthogonal to the first direction is defined as a second direction, the nozzle includes a first nozzle portion passing from the first surface to a connection position in the nozzle substrate and a second nozzle portion that is a hole passing from the connection position to the second surface, the first nozzle portion has a constant width in the second direction regardless of a position in the first direction, and the second nozzle portion has a width in the second direction that gradually increases such that an amount of increase in width in the second direction decreases as a position in the first direction approaches the second surface.

### BRIEF DESCRIPTION OF THE DRAWINGS

FIG. 1 is an explanatory diagram illustrating an example of a liquid ejecting apparatus 100 according to the present embodiment.

FIG. 2 is an exploded perspective view of a liquid ejecting head 1.

FIG. 3 is a cross-sectional view taken along line III-III in FIG. 2.

FIG. 4 is a plan view of the liquid ejecting head 1 viewed in a +Z direction.

FIG. 5 is an enlarged cross-sectional view of the vicinity of a piezoelectric element PZq.

FIG. 6 is a diagram for explaining a drive signal

### Com.

FIG. 7 is a diagram for explaining a phenomenon in which a bubble is mixed into a nozzle NA.

FIG. 8 is a diagram for explaining a state of a force applied to ink in the nozzle NA.

FIG. 9 is a diagram for explaining a state of a force applied to ink in a nozzle NB.

FIG. 10 is a diagram for explaining a reason why a pressure transmitted to a first nozzle portion NP1 becomes excessive.

FIG. 11 is a diagram for explaining the reason why the pressure transmitted to the first nozzle portion NP1 becomes excessive.

FIG. 12 is a diagram of a nozzle N viewed in the +Z direction.

FIG. 13 is a cross-sectional view taken along line XIII-XIII in FIG. 12.

FIG. 14 is a cross-sectional view taken along line XIV-XIV in FIG. 12.

FIG. 15 is a view for explaining a nozzle NC in a second embodiment.

FIG. 16 is a view for explaining a nozzle ND in a first modification.

### DESCRIPTION OF EMBODIMENTS

Hereinafter, embodiments of the present disclosure will be described with reference to the drawings. Meanwhile, in each drawing, the dimensions and scale of each portion are different from the actual dimensions and scale as appropriate. In addition, since the embodiments described below are preferable specific examples of the present disclosure, various technically preferable limitations are added. However, the scope of the present disclosure is not limited to these embodiments unless otherwise specified in the following description.

### A. EMBODIMENT

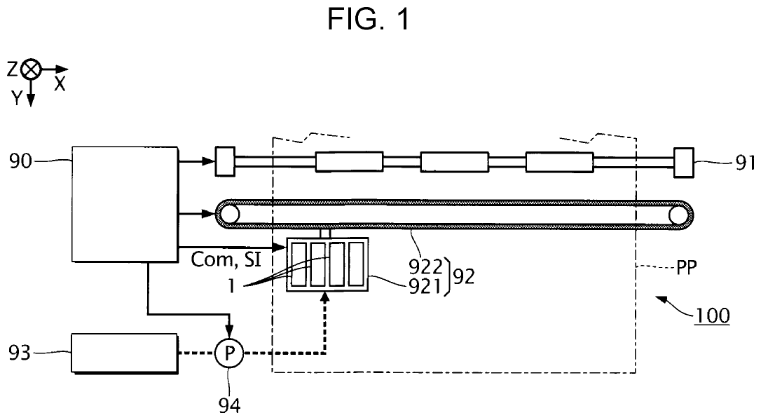

Hereinafter, a liquid ejecting apparatus 100 according to the present embodiment will be described with reference to FIG. 1.

### A1. Overview of Liquid Ejecting Apparatus 100

FIG. 1 is an explanatory diagram illustrating an example of the liquid ejecting apparatus 100 according to the present embodiment. The liquid ejecting apparatus 100 according to the present embodiment is an ink jet printing apparatus that ejects ink onto a medium PP. The medium PP is, for example, printing paper, but any printing target such as a resin film or cloth can be used as the medium PP.

As illustrated in FIG. 1, the liquid ejecting apparatus 100 includes a liquid container 93 that stores ink. As the liquid container 93, for example, a cartridge that can be attached to and detached from the liquid ejecting apparatus 100, a bag-shaped ink pack formed of a flexible film, an ink tank that can be replenished with ink, or the like can be adopted. A plurality of types of ink having different colors is stored in the liquid container 93.

As illustrated in FIG. 1, the liquid ejecting apparatus 100 includes a control device 90, a moving mechanism 91, a transport mechanism 92, and a circulation mechanism 94. Among these elements, the control device 90 includes, for example, a processing circuit such as a CPU or an FPGA and a storage circuit such as a semiconductor memory and controls each element of the liquid ejecting apparatus 100. Here, “CPU” is an abbreviation of “central processing unit”, and “FPGA” is an abbreviation of “field-programmable gate array”. In addition, the moving mechanism 91 transports the medium PP in a +Y direction under the control of the control device 90. Hereinafter, the +Y direction and a −Y direction opposite to the +Y direction are collectively referred to as a Y-axis direction.

In addition, the transport mechanism 92 reciprocates a plurality of liquid ejecting heads 1 in a +X direction and a −X direction opposite to the +X direction under the control of the control device 90. Hereinafter, the +X direction and the −X direction are collectively referred to as an X-axis direction. Here, the +X direction is a direction intersecting the +Y direction. For example, the +X direction is a direction orthogonal to the +Y direction. The transport mechanism 92 includes a storage case 921 that stores the plurality of liquid ejecting heads 1 and an endless belt 922 to which the storage case 921 is fixed. The liquid container 93 and the circulation mechanism 94 may be stored in the storage case 921 together with the liquid ejecting heads 1.

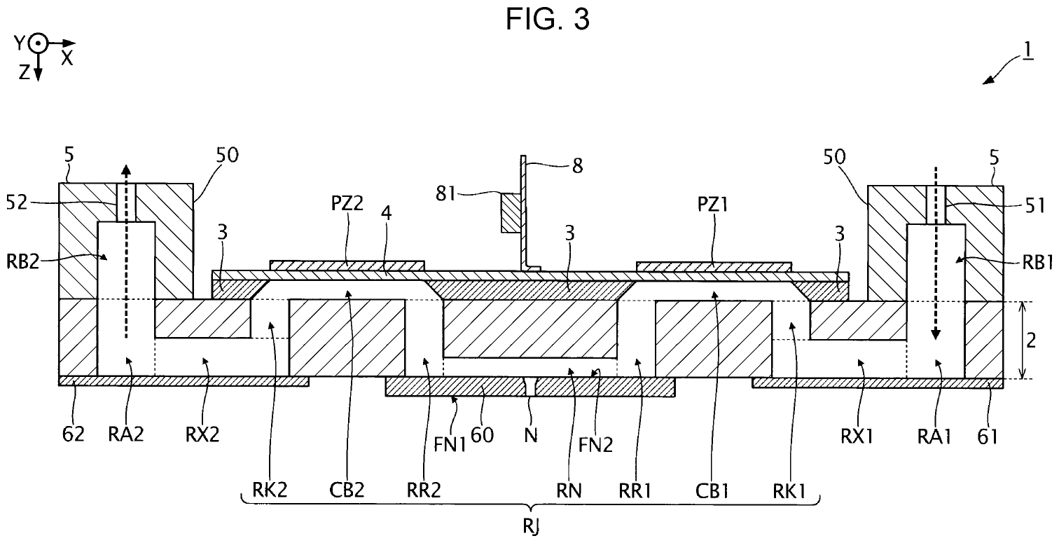

In addition, the circulation mechanism 94 supplies the ink stored in the liquid container 93 to a supply flow path RB1 provided in each liquid ejecting head 1 under the control of the control device 90. Further, under the control of the control device 90, the circulation mechanism 94 collects the ink stored in a discharge flow path RB2 provided in each liquid ejecting head 1 and returns the collected ink to the supply flow path RB1. The supply flow path RB1 and the discharge flow path RB2 will be described later with reference to FIG. 3.

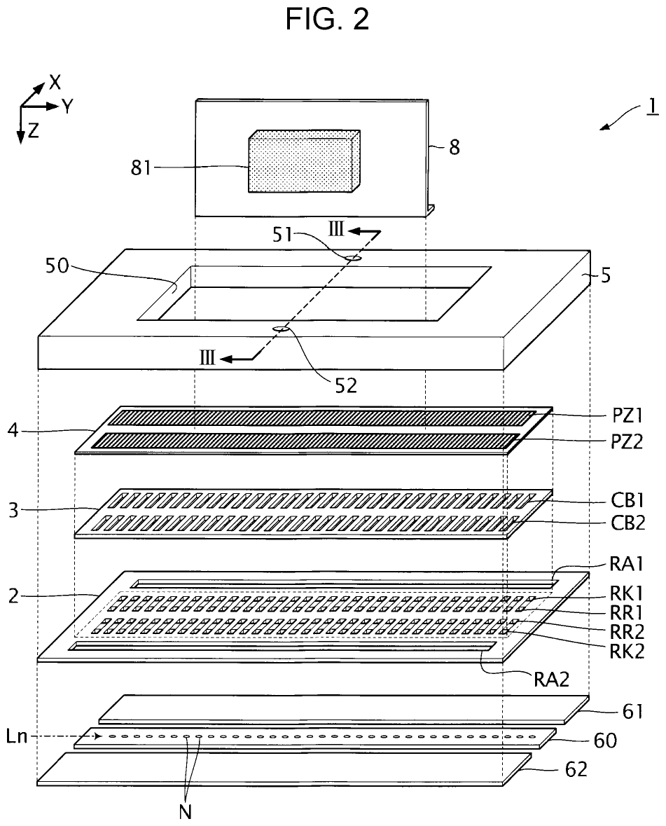

As illustrated in FIG. 1, the control device 90 supplies a drive signal Com for driving the liquid ejecting heads 1 and a control signal SI for controlling the liquid ejecting heads 1 to the liquid ejecting heads 1. Then, the liquid ejecting heads 1 are driven by the drive signal Com under the control of the control signal SI and eject the ink in a +Z direction from some or all of M nozzles N provided in the liquid ejecting heads 1. Here, the value M is an integer of 1 or more. The +Z direction is a direction intersecting the +X direction and the +Y direction. For example, the +Z direction is a direction orthogonal to the +X direction and the +Y direction. Hereinafter, the +Z direction and a −Z direction opposite to the +Z direction may be collectively referred to as a Z-axis direction. In order to facilitate intuitive understanding of the description, the +Z direction may be referred to as a “downward direction”, and the −Z direction may be referred to as an “upward direction”. Further, a downward portion of an element may be described as a “lower portion”, and an upward portion of an element may be described as an “upper portion”. The nozzles N will be described later with reference to FIGS. 2 to 4.

The liquid ejecting heads 1 form a desired image on a surface of the medium PP by ejecting ink from some or all of the M nozzles N and causing the ejected ink to land on the surface of the medium PP in conjunction with the transport of the medium PP by the moving mechanism 91 and the reciprocation of the liquid ejecting heads 1 by the transport mechanism 92.

### A2. Overview of Liquid Ejecting Heads 1

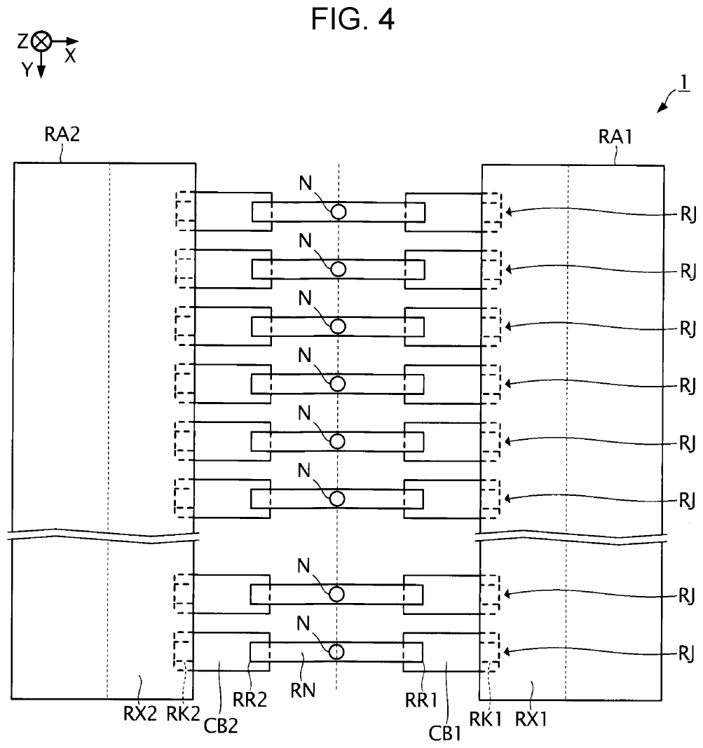

Hereinafter, the overview of the liquid ejecting heads 1 will be described with reference to FIGS. 2 to 5. FIG. 2 is an exploded perspective view of the liquid ejecting heads 1, FIG. 3 is a cross-sectional view taken along line III-III in FIG. 2, and FIG. 4 is a plan view of the liquid ejecting heads 1 viewed in the +Z direction.

As illustrated in FIGS. 2 and 3, each of the liquid ejecting heads 1 includes a nozzle substrate 60, a compliance sheet 61 and a compliance sheet 62, a communication plate 2, a pressure chamber substrate 3, a vibration plate 4, a storage chamber forming substrate 5, and a wiring substrate 8.

As illustrated in FIG. 2, the nozzle substrate 60 is a plate-shaped member that is elongated in the Y-axis direction and extends substantially parallel to an XY plane, and the M nozzles N are formed therein. Here, “substantially parallel” is a concept that includes not only a state of being completely parallel but also a state of being regarded as parallel in consideration of an error. The nozzle substrate 60 is manufactured, for example, by processing a silicon single crystal substrate using a semiconductor manufacturing technique such as etching. However, a known material and a known manufacturing method can be appropriately adopted for manufacturing the nozzle substrate 60. In addition, the nozzles N are through-holes provided in the nozzle substrate 60. In the present embodiment, as an example, it is assumed that the M nozzles N are provided in the nozzle substrate 60 so as to form a nozzle row Ln extending in the Y-axis direction.

The nozzle substrate 60 has a surface FN1 facing in the +Z direction and a surface FN2 facing in the −Z direction. The surface FN2 is bonded to the communication plate 2. In addition, the surface FN2 is closer to the pressure chamber substrate 3 than is the surface EN1. The surface FN1 is an example of a “first surface”. The surface FN2 is an example of a “second surface”.

As illustrated in FIGS. 2 and 3, the communication plate 2 is provided in the −Z direction of the nozzle substrate 60. The communication plate 2 is a plate-shaped member that is elongated in the Y-axis direction and extends substantially parallel to the XY plane, and an ink flow path is formed therein.

Specifically, one supply flow path RA1 and one discharge flow path RA2 are formed in the communication plate 2. Among these elements, the supply flow path RA1 is in communication with the supply flow path RB1, which will be described later, and is provided so as to extend in the Y-axis direction. In addition, the discharge flow path RA2 is in communication with the discharge flow path RB2, which will be described later, and is provided in the −X direction when viewed from the supply flow path RA1 so as to extend in the Y-axis direction.

In addition, M nozzle flow paths RN corresponding to the M nozzles N on a one-to-one basis, M communication flow paths RR1 corresponding to the M nozzles N on a one-to-one basis, M communication flow paths RR2 corresponding to the M nozzles N on a one-to-one basis, M communication flow paths RK1 corresponding to the M nozzles N on a one-to-one basis, M communication flow paths RK2 corresponding to the M nozzles N on a one-to-one basis, one communication flow path RX1 common to the M nozzles N, and one communication flow path RX2 common to the M nozzles N are formed in the communication plate 2. The communication plate 2 may be provided with M communication flow paths RX1 corresponding to the M nozzles N on a one-to-one basis and M communication flow paths RX2 corresponding to the M nozzles N on a one-to-one basis.

Among these elements, the communication flow path RX1 is in communication with the supply flow path RA1 and is provided in the −X direction when viewed from the supply flow path RA1 so as to extend in the X-axis direction. In addition, each communication flow path RK1 is in communication with the communication flow path RX1 at an end portion in the +Z direction and is provided so as to extend in the Z-axis direction. In addition, each communication flow path RR1 is provided in the −X direction when viewed from the corresponding communication flow path RK1 so as to extend in the Z-axis direction.

In addition, the communication flow path RX2 is in communication with the discharge flow path RA2 and is provided in the +X direction when viewed from the discharge flow path RA2 so as to extend in the X-axis direction. In addition, each communication flow path RK2 is in communication with the communication flow path RX2 at an end portion in the +Z direction and is provided so as to extend in the Z-axis direction. In addition, each communication flow path RR2 is provided in the +X direction when viewed from the corresponding communication flow path RK2 and in the −X direction when viewed from the corresponding communication flow path RR1, so as to extend in the Z-axis direction.

In addition, each nozzle flow path RN causes the corresponding communication flow path RR1 to communicate with the corresponding communication flow path RR2, and is provided in the −X direction when viewed from the corresponding communication flow path RR1 and in the +X direction when viewed from the corresponding communication flow path RR2, so as to extend in the X-axis direction. The nozzle flow paths RN are in communication with the nozzles N corresponding to the nozzle flow paths RN.

For example, the communication plate 2 is manufactured by processing a silicon single crystal substrate using a semiconductor manufacturing technique. However, a known material and a known manufacturing method can be appropriately adopted for manufacturing the communication plate 2.

As illustrated in FIGS. 2 and 3, the pressure chamber substrate 3 is provided on the −Z side of the communication plate 2. The pressure chamber substrate 3 is a plate-shaped member that is elongated in the Y-axis direction and extends substantially parallel to the XY plane, and an ink flow path is formed therein.

Specifically, in the pressure chamber substrate 3, M pressure chambers CB1 corresponding to the M nozzles N on a one-to-one basis and M pressure chambers CB2 corresponding to the M nozzles N on a one-to-one basis are formed. Among these elements, each pressure chamber CB1 causes the corresponding communication flow path RK1 to communicate with the corresponding communication flow path RR1, connects an end portion on the +X side of the communication flow path RK1 and an end portion on the −X side of the communication flow path RR1 when viewed in the Z-axis direction and is provided so as to extend in the X-axis direction. In addition, each pressure chamber CB2 causes the corresponding communication flow path RK2 to communicate with the corresponding communication flow path RR2, connects an end portion on the −X side of the communication flow path RK2 and an end portion on the +X side of the communication flow path RR2 when viewed in the Z-axis direction and is provided so as to extend in the X-axis direction.

For example, the pressure chamber substrate 3 is manufactured by processing a silicon single crystal substrate using a semiconductor manufacturing technique. However, a known material and a known manufacturing method can be appropriately adopted for manufacturing the pressure chamber substrate 3.

Hereinafter, an ink flow path that causes the supply flow path RA1 and the discharge flow path RA2 to communicate with each other is referred to as a circulation flow path RJ. As illustrated in FIG. 4, the communication flow path RX1 and the communication flow path RX2 are in communication with each other through M circulation flow paths RJ corresponding to the M nozzles N on a one-to-one basis. As described above, each of the circulation flow paths RJ includes the corresponding communication flow path RK1 in communication with the communication flow path RX1, the corresponding pressure chamber CB1 in communication with the communication flow path RK1, the corresponding communication flow path RR1 in communication with the pressure chamber CB1, the corresponding nozzle flow path RN in communication with the communication flow path RR1, the corresponding communication flow path RR2 in communication with the nozzle flow path RN, the corresponding pressure chamber CB2 in communication with the communication flow path RR2, and the corresponding communication flow path RK2 in communication with the pressure chamber CB2. In the present embodiment, as an example, it is assumed that each circulation flow path RJ extends in the X-axis direction.

As understood from FIG. 3, each nozzle N causes the corresponding circulation flow path RJ to communicate with the outside so as to pass through the nozzle substrate 60 from the surface FN1 to the surface FN2. The circulation flow paths RJ are provided by the pressure chamber substrate 3 and the communication plate 2. The circulation flow paths RJ are an example of a “flow path”. The pressure chamber substrate 3 and the communication plate 2 are an example of a “flow path substrate”. In other words, in a first embodiment, the “flow path substrate” includes the pressure chamber substrate 3 and the communication plate 2.

As illustrated in FIGS. 2 and 3, the vibration plate 4 is provided on the −Z side of the pressure chamber substrate 3. The vibration plate 4 is a plate-shaped member that is elongated in the Y-axis direction, extends substantially parallel to the XY plane, and is capable of vibrating elastically.

As illustrated in FIGS. 2 and 3, M piezoelectric elements PZ1 corresponding to the M pressure chambers CB1 on a one-to-one basis and M piezoelectric elements PZ2 corresponding to the M pressure chambers CB2 on a one-to-one basis are provided on the −Z side of the vibration plate 4. Hereinafter, the piezoelectric elements PZ1 and the piezoelectric elements PZ2 are collectively referred to as a piezoelectric element PZq. The piezoelectric element PZq is a passive element that deforms according to a potential change of the drive signal Com. In other words, the piezoelectric element PZq is an example of an “energy generation element” that generates energy for ejecting ink from the corresponding nozzle N, based on the drive signal Com. Hereinafter, in the liquid ejecting head 1, the suffix “q” may be added to a reference numeral indicating a component or a signal corresponding to the piezoelectric element PZq.

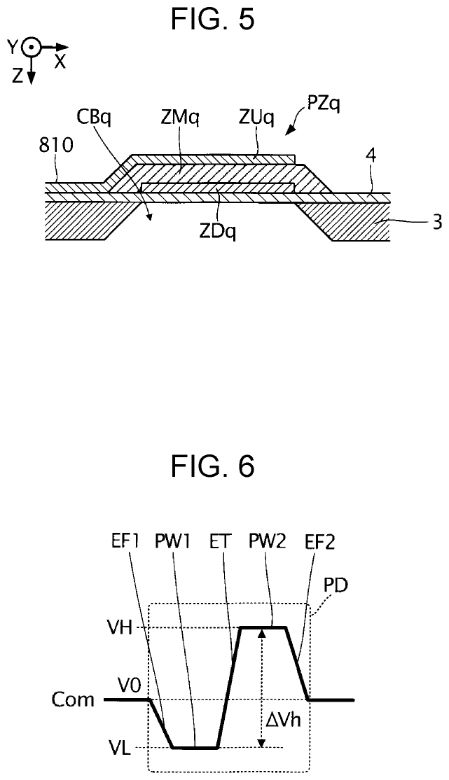

FIG. 5 is an enlarged cross-sectional view of the vicinity of the piezoelectric element PZq. As illustrated in FIG. 5, the piezoelectric element PZq is a layered body in which a piezoelectric body ZMq is interposed between a lower electrode ZDq to which a predetermined reference potential VBS is supplied and an upper electrode ZUq to which the drive signal Com is supplied. The piezoelectric element PZq is, for example, a portion where the lower electrode ZDq, the upper electrode ZUq, and the piezoelectric body ZMq overlap when viewed in the −Z direction. In addition, a pressure chamber CBq is provided in the +Z direction of the piezoelectric element PZq.

As described above, the piezoelectric element PZq is driven and deformed according to a potential change of the drive signal Com. The vibration plate 4 vibrates in conjunction with the deformation of the piezoelectric element PZq. When the vibration plate 4 vibrates, the pressure in the pressure chamber CBq varies. When the pressure in the pressure chamber CBq varies, the ink filled in the pressure chamber CBq is ejected from the nozzle N through a communication flow path RRq and the nozzle flow path RN.

As illustrated in FIGS. 2 and 3, the wiring substrate 8 is mounted on a surface on the −Z side of the vibration plate 4. The wiring substrate 8 is a component for electrically connecting the control device 90 and the corresponding liquid ejecting head 1. As the wiring substrate 8, for example, a flexible wiring substrate such as an FPC or an FFC is suitably adopted. Here, “FPC” is an abbreviation of “flexible printed circuit”, and “FFC” is an abbreviation of “flexible flat cable”. A drive circuit 81 is mounted on the wiring substrate 8. The drive circuit 81 is an electric circuit that switches whether to supply the drive signal Com to the piezoelectric element PZq under the control of the control signal SI. As illustrated in FIG. 5, the drive circuit 81 supplies the drive signal Com to the upper electrode ZUq of the piezoelectric element PZq through wiring 810.

Hereinafter, the drive signal Com supplied to the piezoelectric elements PZ1 may be referred to as a drive signal Com1, and the drive signal Com supplied to the piezoelectric elements PZ2 may be referred to as a drive signal Com2. In the present embodiment, it is assumed that the waveform of the drive signal Com1 supplied by the drive circuit 81 to the piezoelectric element PZ1 corresponding to the nozzle N is substantially the same as the waveform of the drive signal Com2 supplied by the drive circuit 81 to the piezoelectric element PZ2 corresponding to the nozzle N when ink is ejected from the nozzle N. Here, “substantially the same” is a concept including not only a case of being completely the same but also a case of being regarded as the same in consideration of an error.

As illustrated in FIGS. 2 and 3, the storage chamber forming substrate 5 is provided on the −Z side of the communication plate 2. The storage chamber forming substrate 5 is a member that is elongated in the Y-axis direction, and an ink flow path is formed therein.

Specifically, the one supply flow path RB1 and the one discharge flow path RB2 are formed in the storage chamber forming substrate 5. Among these elements, the supply flow path RB1 is in communication with the supply flow path RA1 and is provided in the −Z direction when viewed from the supply flow path RA1 so as to extend in the Y-axis direction. In addition, the discharge flow path RB2 is in communication with the discharge flow path RA2 and is provided in the −Z direction when viewed from the discharge flow path RA2 and in the −X direction when viewed from the supply flow path RB1 so as to extend in the Y-axis direction.

In addition, an introduction port 51 in communication with the supply flow path RB1 and a discharge port 52 in communication with the discharge flow path RB2 are provided in the storage chamber forming substrate 5. The supply flow path RB1 is supplied with ink from the liquid container 93 through the introduction port 51. In addition, the ink stored in the discharge flow path RB2 is collected through the discharge port 52. Moreover, an opening 50 is provided in the storage chamber forming substrate 5. The pressure chamber substrate 3, the vibration plate 4, and the wiring substrate 8 are provided inside the opening 50. The storage chamber forming substrate 5 is formed by, for example, injection molding of a resin material. However, a known material and a known manufacturing method can be appropriately adopted for manufacturing the storage chamber forming substrate 5.

In the present embodiment, the ink supplied to the introduction port 51 from the liquid container 93 flows into the supply flow path RA1 through the supply flow path RB1. Then, a portion of the ink flowing into the supply flow path RA1 flows into the pressure chambers CB1 through the communication flow path RX1 and the communication flow paths RK1. In addition, a portion of the ink flowing into the pressure chambers CB1 flows into the pressure chambers CB2 through the communication flow paths RR1, the nozzle flow paths RN, and the communication flow paths RR2. Then, a portion of the ink flowing into the pressure chambers CB2 is discharged from the discharge port 52 through the communication flow paths RK2, the communication flow path RX2, the discharge flow path RA2, and the discharge flow path RB2. When the piezoelectric elements PZ1 are driven by the drive signal Com1, a portion of the ink in the pressure chambers CB1 is ejected from the nozzles N through the communication flow paths RR1 and the nozzle flow paths RN. In addition, when the piezoelectric elements PZ2 are driven by the drive signal Com2, a portion of the ink in the pressure chambers CB2 is ejected from the nozzles N through the communication flow paths RR2 and the nozzle flow paths RN.

As illustrated in FIGS. 2 and 3, the compliance sheet 61 is provided on a surface on the +Z side of the communication plate 2 so as to close the supply flow path RA1, the communication flow path RX1, and the communication flow paths RK1. The compliance sheet 61 is formed of an elastic material and absorbs a pressure change of the ink in the supply flow path RA1, the communication flow path RX1, and the communication flow paths RK1. In addition, the compliance sheet 62 is provided on the surface on the +Z side of the communication plate 2 so as to close the discharge flow path RA2, the communication flow path RX2, and the communication flow paths RK2. The compliance sheet 62 is formed of an elastic material and absorbs a pressure change of the ink in the discharge flow path RA2, the communication flow path RX2, and the communication flow paths RK2.

As described above, the liquid ejecting heads 1 according to the present embodiment circulate ink from the communication flow path RX1 to the communication flow path RX2 through the circulation flow paths RJ. Therefore, in the present embodiment, even in a case where there is a period in which the ink inside the pressure chamber CBq is not ejected from the nozzle N, it is possible to prevent a state in which the ink is retained inside the pressure chamber CBq, in the nozzle flow path RN, and the like from continuing. Accordingly, in the present embodiment, even in a case where there is a period in which the ink inside the pressure chamber CBq is not ejected from the nozzle N, it is possible to suppress an increase in viscosity of the ink inside the pressure chamber CBq, and it is possible to prevent occurrence of an ejection abnormality in which the ink cannot be ejected from the nozzle N due to an increase in viscosity of the ink.

In addition, the liquid ejecting heads 1 according to the present embodiment can eject the ink in the pressure chambers CB1 and the ink in the pressure chambers CB2 from the nozzles N. Therefore, in the liquid ejecting heads 1 according to the present embodiment, for example, it is possible to increase the amount of ink ejected from the nozzles N compared to an aspect in which only the ink in one pressure chamber CBq is ejected from the nozzle N.

### A3. Drive Signal Com

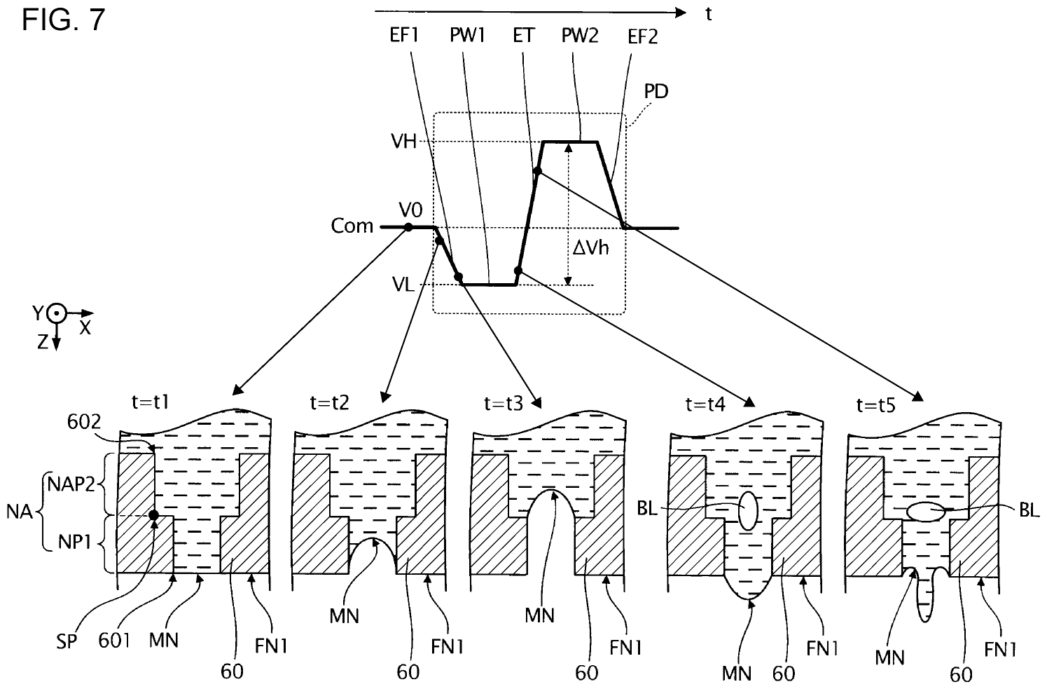

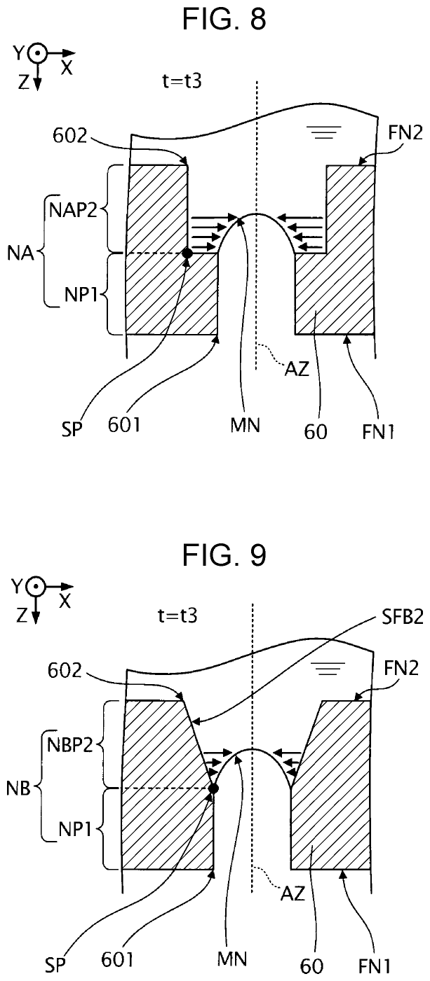

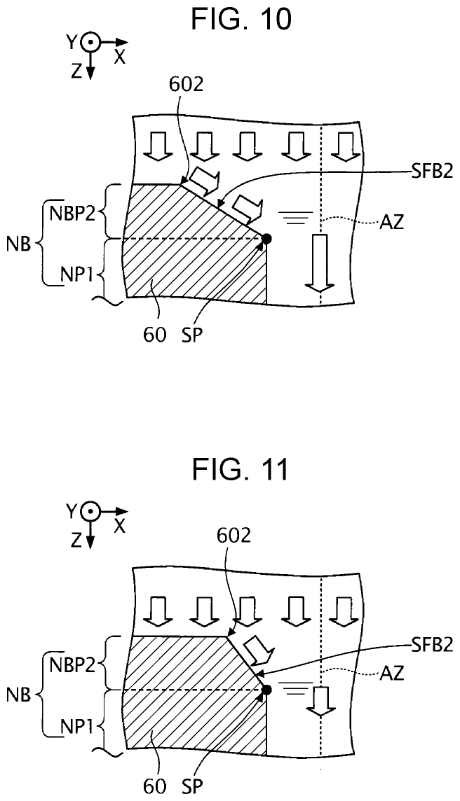

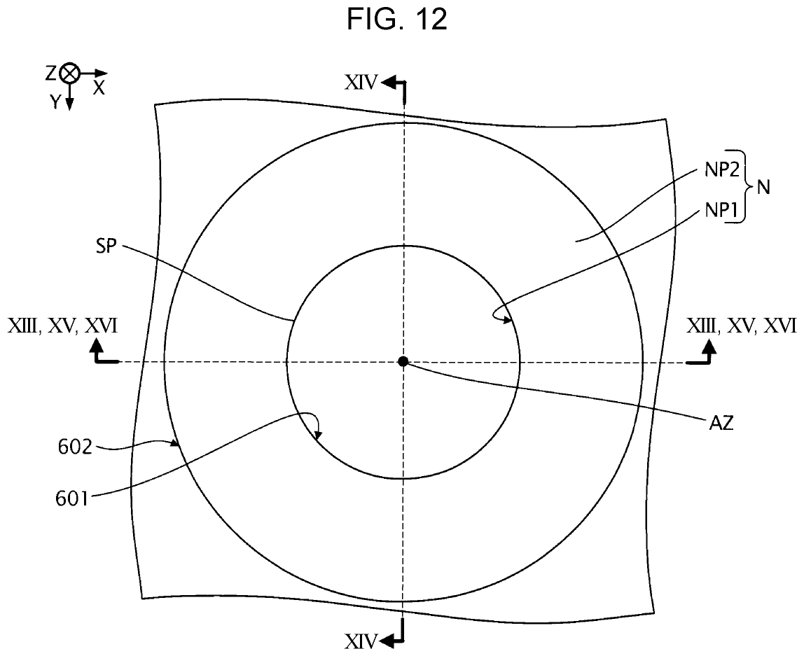

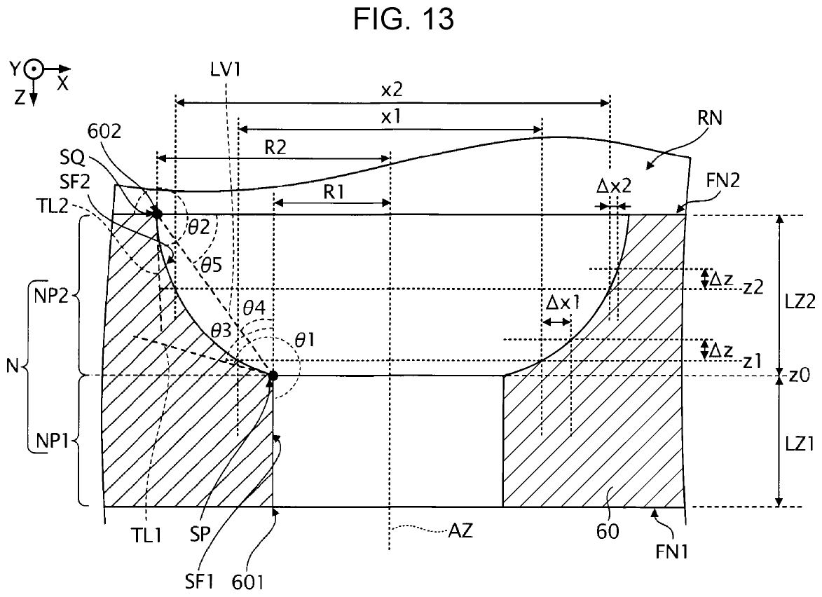

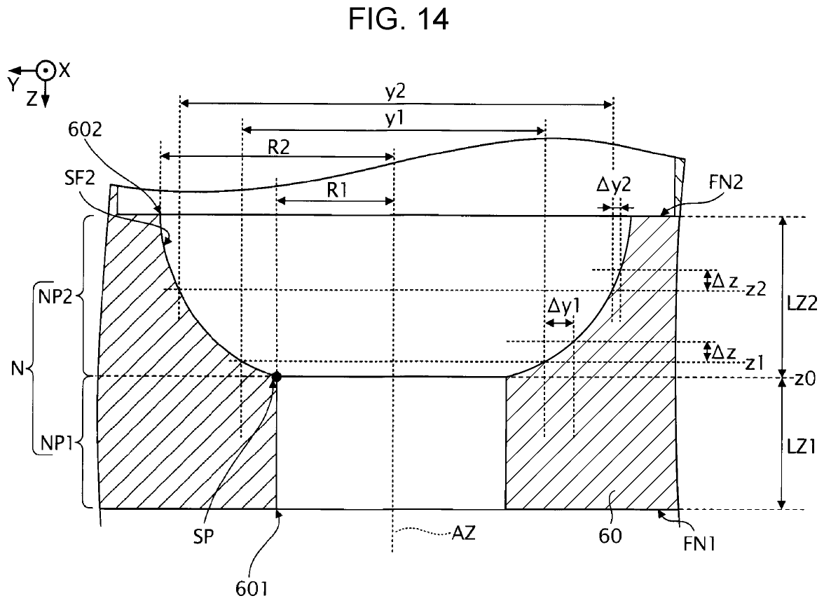

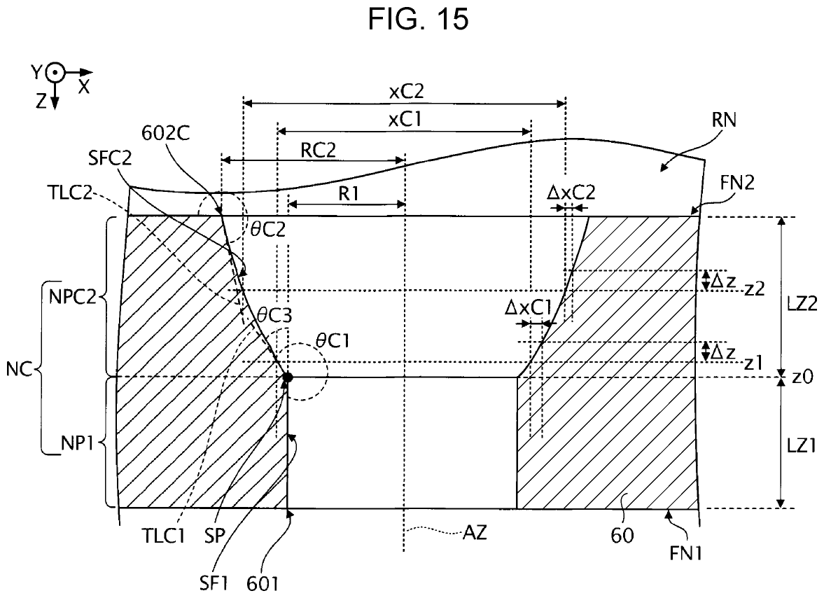

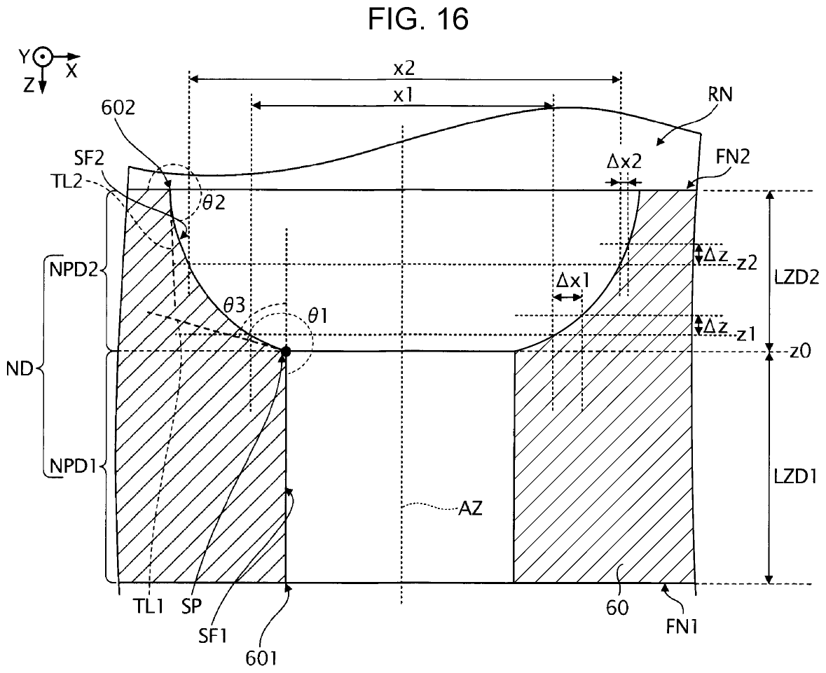

FIG. 6 is a diagram illustrating the drive signal Com. The drive signal Com has one or a plurality of ejection waveforms PD illustrated in FIG. 6. The ejection waveform PD has a first expanding element EF1, a first holding element PW1, a contracting element ET, a second holding element PW2, and a second expanding element EF2 in this order.

The first expanding element EF1 changes a potential so as to expand the pressure chamber CBq. Specifically, the first expanding element EF1 changes the potential from a reference potential V0, which is a start potential of the ejection waveform PD, to a lowest potential VL. The first holding element PW1 is connected to an end of the first expanding element EF1 and maintains the lowest potential VL. The contracting element ET is connected to an end of the first holding element PW1 and changes the potential so as to contract the pressure chamber CBq. Specifically, the contracting element ET changes the potential from the lowest potential VL to a highest potential VH. The second holding element PW2 is connected to an end of the contracting element ET and maintains the highest potential VH. The second expanding element EF2 is connected to an end of the second holding element PW2 and changes the potential so as to expand the pressure chamber CBq. Specifically, the second expanding element EF2 changes the potential from the highest potential VH to the reference potential V0.

When the ejection waveform PD is supplied, the piezoelectric element PZq generates a negative pressure in the pressure chamber CBq based on the first expanding element EF1 and then generates a positive pressure in the pressure chamber CBq based on the contracting element ET, thereby ejecting the ink from the nozzle N. When a negative pressure is generated in the pressure chamber CBq, the surface of the ink in the nozzle N is pulled in the −Z direction. Hereinafter, the surface of the ink in the nozzle N may be referred to as a “meniscus”. Further, pulling the meniscus in the −Z direction may be referred to as “pull”.

When a positive pressure is generated in the pressure chamber CBq, the meniscus is pushed out in the +Z direction. Hereinafter, pushing the meniscus in the +Z direction may be referred to as “push”. The ejection waveform PD is a so-called pull-push-pull waveform.

Hereinafter, a potential difference between the highest potential VH and the lowest potential VL in the ejection waveform PD may be referred to as a potential difference ΔVh.

### A4. Shape of Nozzles N

Since the meniscus is in contact with air, a solvent such as water contained in the ink may evaporate and the viscosity of the ink may be increased. As a method of dissolving the increase in viscosity of the ink in the vicinity of the nozzles N, it is considered that the ink whose viscosity is not increased is supplied to the circulation flow paths RJ, and the ink whose viscosity is increased in the vicinity of the nozzles N is replaced with the ink whose viscosity is not increased. In order to efficiently exchange the ink in the vicinity of the nozzles N, it is considered that the nozzles N include a first nozzle portion passing from the surface FN1 to a connection position SP in the nozzle substrate 60 in the Z-axis direction and a second nozzle portion that is a hole passing from the connection position SP to the surface FN2. For example, a nozzle NA according to a first reference example having a first nozzle portion NP1 provided in the same shape as an opening 601 provided in the surface FN1 in the Z-axis direction and a second nozzle portion NAP2 provided in the surface FN2 in the Z-axis direction and provided in the same shape as an opening 602, which is larger than the opening 601, is considered. However, in the nozzle NA, a bubble may be mixed into the nozzle NA. When a bubble is mixed into the nozzle NA, compliance of the bubble is large, and thus the Helmholtz natural vibration frequency in the flow path changes. Hereinafter, the Helmholtz natural vibration frequency in the flow path may be referred to as a natural vibration frequency Tc. Compliance is a physical quantity representing ease of deformation with respect to pressure. Since the ejection waveform PD is designed to appropriately eject ink in a state where there is no bubble in the flow path, if the natural vibration frequency Tc changes, there is a possibility that the ejection of the ink becomes unstable. Unstable ejection means that, for example, an ejecting direction of ink deviates from a predetermined direction, ink is not ejected from the nozzle N, and the amount of ejected ink varies. A phenomenon in which a bubble is mixed into the nozzle NA will be described with reference to FIG. 7.

FIG. 7 is a diagram for explaining the phenomenon in which a bubble is mixed into the nozzle NA of the first reference example. FIG. 7 illustrates a state of ink in the vicinity of the nozzle NA before the ejection waveform PD is supplied to the piezoelectric element PZq and while the ejection waveform PD is being supplied to the piezoelectric element PZq, in a case where the nozzle N is the nozzle NA.

At a time t1 before the ejection waveform PD is supplied to the piezoelectric element PZq, vibration of a meniscus MN caused by the previous ejection waveform PD is attenuated. Further, at the time t1, the meniscus MN is present at substantially the same position as the opening 601 in the Z-axis direction in a state of being substantially parallel to the XY plane.

At a time t2 immediately after the first expanding element EF1 starts to be supplied to the piezoelectric element PZq, the meniscus MN is pulled in the −Z direction. Next, at a time t3 which is a time immediately before the supply of the first expanding element EF1 to the piezoelectric element PZq is ended, an apex of the meniscus MN in the −Z direction is included inside the second nozzle portion NAP2.

At a time t4 which is a time immediately after the contracting element ET starts to be supplied to the piezoelectric element PZq, the meniscus MN is pushed in the +Z direction. Further, a portion of the apex of the meniscus MN in the −Z direction is taken into the nozzle NA as a bubble BL. Next, at a time t5 which is a time immediately before the supply of the contracting element ET to the piezoelectric element PZq is ended, the meniscus MN is further pushed in the +Z direction. Even at the time t5, the bubble BL is present inside the nozzle NA.

The phenomenon illustrated in FIG. 7 is more likely to occur when the following three conditions are satisfied. The first condition is that the reference potential V0 is high. The second condition is that the period of the first expanding element EF1 and the period of the contracting element ET are short. The third condition is that the potential difference ΔVh is large.

The phenomenon illustrated in FIG. 7 can also occur in an aspect different from an aspect in which the ejection waveform PD is supplied to the piezoelectric element PZq. For example, even in an aspect in which the second expanding element EF2 is removed from the ejection waveform PD, that is, an aspect in which a so-called pull-push waveform is supplied to the piezoelectric element PZq, the phenomenon illustrated in FIG. 7 can occur.

The reason why a bubble is mixed will be described using the nozzle NA and a nozzle NB, which is a second reference example.

FIG. 8 is a diagram for explaining a state of a force applied to the ink in the nozzle NA. FIG. 9 is a diagram for explaining a state of a force applied to the ink in the nozzle NB. The nozzle NB is different from the nozzle NA in that the nozzle NB has a second nozzle portion NBP2 instead of the second nozzle portion NAP2. The second nozzle portion NBP2 is different from the second nozzle portion NAP2 in that an inner surface of the second nozzle portion NBP2 is linearly inclined with respect to the Z-axis direction. FIG. 8 illustrates a state of a force applied to the ink in the nozzle NA in the state at the time t3 illustrated in FIG. 7. FIG. 9 illustrates a state of a force applied to the ink in the nozzle NB in the state at the time t3 when the ejection waveform PD is supplied to the piezoelectric element PZq corresponding to the pressure chamber CBq in communication with the nozzle NB. In FIGS. 8 and 9, the arrows illustrated in the ink indicate the magnitude and direction of the force applied to the ink.

As understood from FIGS. 8 and 9, the volume of the ink in a lower portion of the second nozzle portion NBP2 is smaller than the volume of the ink in a lower portion of the second nozzle portion NAP2. Therefore, the magnitude of the force toward a nozzle central axis AZ in the ink of the nozzle NB is smaller than the magnitude of the force toward the nozzle central axis AZ in the ink of the nozzle NA. By reducing the magnitude of the force toward the nozzle central axis AZ, the force that directs the ink toward the nozzle central axis AZ is reduced, and thus a bubble taken into the nozzle NB can be suppressed compared to the nozzle NA.

However, even in the nozzle NB, in which the inside of the second nozzle portion NBP2 has a surface linearly inclined with respect to the Z-axis direction, the meniscus MN may be broken, and a bubble may be mixed into the nozzle NB. Hereinafter, a case where a bubble is mixed into the nozzle NB will be described.

When the inclination of a wall surface SFB2 is gentle in an upper portion of the second nozzle portion NBP2 of the nozzle NB, the meniscus MN collapses, and mixing of a bubble may occur. In general, pressure is applied to a nozzle from a pressure chamber located further in the −Z direction than is the nozzle, and thus ink is ejected from the nozzle. The vicinity of the upper portion of the second nozzle portion NBP2 is a region to which pressure from the pressure chamber CBq is applied. When the inclination of the wall surface SFB2 in the vicinity of the upper portion of the second nozzle portion NBP2 is gentle, there is a possibility that the pressure transmitted toward the first nozzle portion NP1 of the nozzle NB becomes excessive. Hereinafter, a case where the pressure transmitted toward the first nozzle portion NP1 of the nozzle NB becomes excessive will be described with reference to FIGS. 10 and 11.

FIGS. 10 and 11 are diagrams for explaining the case where the pressure transmitted toward the first nozzle portion NP1 of the nozzle NB becomes excessive. The arrows in the ink illustrated in FIGS. 10 and 11 indicate the magnitude and direction of the pressure from the pressure chamber CBq. The inclination of the wall surface SFB2 illustrated in FIG. 10 is gentler than the inclination of the wall surface SFB2 illustrated in FIG. 11. As understood from FIGS. 10 and 11, in a state where the wall surface SFB2 of the second nozzle portion NBP2 is linearly inclined with respect to the Z-axis direction, the opening 602 is increased in size as the inclination of the wall surface SFB2 becomes gentler. Since the magnitude of the force is a value obtained by multiplying the area by the pressure, when the size of the opening 602 is increased, that is, when the area of the opening 602 is increased, the magnitude of a downward force from the pressure chamber CBq toward the surface FN2 is increased. Since the cross-sectional area of the first nozzle portion NP1 in the Z-axis direction is the same in FIG. 10 and FIG. 11, in the nozzle NB illustrated in FIG. 10, the pressure transmitted toward the first nozzle portion NP1 of the nozzle NB becomes excessive compared to the nozzle NB illustrated in FIG. 11. When the pressure transmitted toward the first nozzle portion NP1 of the nozzle NB becomes excessive, there is a possibility that the meniscus MN is broken.

When the inclination of the wall surface SFB2 is steep in the lower portion of the second nozzle portion NBP2 of the nozzle NB, the apex of the meniscus MN in the −Z direction easily reaches the second nozzle portion NBP2, the meniscus MN collapses, and mixing of a bubble may occur. In general, the smaller the cross-sectional area of the nozzle when viewed in the Z-axis direction is, the more easily the meniscus MN flows in the Z-axis direction. This is because when the volume of the pressure chamber CBq fluctuates, the ink inside the nozzle N increases or decreases according to the fluctuated volume. Since the size of the volume is, for example, a value obtained by multiplying the cross-sectional area by the height when the cross-sectional shape is constant, the length of the flow in the Z-axis direction increases as the cross-sectional area of the nozzle in the Z-axis direction decreases. When the inclination of the wall surface SFB2 is steep in the lower portion of the second nozzle portion NBP2, it means that the cross-sectional area does not change so much when viewed in the Z-axis direction. Therefore, since the ease of flow of the meniscus MN in the Z-axis direction is not so different between the first nozzle portion NP1 and the second nozzle portion NBP2, it is considered that the meniscus MN easily flows to the second nozzle portion NBP2. On the other hand, when the inclination of the wall surface SFB2 is gentle in the lower portion of the second nozzle portion NBP2, the cross-sectional area of the second nozzle portion NBP2 viewed in the Z-axis direction is larger than the cross-sectional area of the first nozzle portion NP1 viewed in the Z-axis direction. Therefore, since the ease of flow of the meniscus MN in the Z-axis direction in the second nozzle portion NBP2 is smaller than the ease of flow of the meniscus MN in the Z-axis direction in the first nozzle portion NP1, the apex of the meniscus MN in the −Z direction is less likely to reach the inside of the second nozzle portion NBP2, and the meniscus MN is less likely to collapse.

As described above, it has been found from the experiments and experiences of the inventors that the inclination of the wall surface SFB2 is preferably steep in the upper portion of the second nozzle portion NBP2 of the nozzle N, and the inclination of the wall surface SFB2 is preferably gentle in the lower portion of the second nozzle portion NBP2. Hereinafter, the nozzles N in the first embodiment will be described with reference to FIGS. 12 to 14.

### A5. Shape of Nozzles N in First Embodiment

FIG. 12 is a diagram of each of the nozzles N viewed in the +Z direction. FIG. 13 is a cross-sectional view taken along line XIII-XIII in FIG. 12, and FIG. 14 is a cross-sectional view taken along line XIV-XIV in FIG. 12. The nozzles N are different from the nozzle NA and the nozzle NB in that the nozzles N include a second nozzle portion NP2. The first nozzle portion NP1 passes from the surface FN1 to the connection position SP in the nozzle substrate 60. The second nozzle portion NP2 is a hole passing from the connection position SP to the surface FN2. The first nozzle portion NP1 has a constant width in the X-axis direction regardless of the position in the Z-axis direction. Specifically, the width of the first nozzle portion NP1 in the X-axis direction is twice a radius R1 of the opening 601. As illustrated in FIGS. 13 and 14, the first nozzle portion NP1 extends in the Z-axis direction. However, an extending direction of the first nozzle portion NP1 is not limited to the Z-axis direction, and may be inclined with respect to the Z-axis direction. As illustrated in FIG. 12, when viewed in the +Z direction, a contour of the opening 601 and a contour of the opening 602 are circular. However, the contour of the opening 601 and the contour of the opening 602 are not limited to a circular shape, and may be an elliptical shape. As illustrated in FIG. 12, when viewed in the +Z direction, a center of the opening 601 and a center of the opening 602 overlap with the nozzle central axis AZ.

The Z-axis direction is an example of a “first direction”. The X-axis direction is an example of a “second direction”. The Y-axis direction is an example of a “third direction”. However, the “second direction” is not limited to the X-axis direction as long as the second direction is a direction perpendicular to the Z-axis direction. In addition, the “third direction” is sufficient as long as the third direction is a direction perpendicular to the “first direction” and the “second direction”.

As illustrated in FIGS. 13 and 14, the position of the connection position SP in the Z-axis direction is a position z0.

The second nozzle portion NP2 has a width in the X-axis direction that gradually increases such that the amount of increase in width in the X-axis direction decreases as the position in the Z-axis direction approaches the surface FN2. In other words, the inclination of a wall surface SF2 is gentle in the lower portion of the second nozzle portion NP2, and the inclination of the wall surface SF2 becomes steeper toward the upper portion of the second nozzle portion NP2. A minimum width of the second nozzle portion NP2 in the X-axis direction is twice the radius R1 of the opening 601. A longest width of the second nozzle portion NP2 in the X-axis direction is twice a radius R2 of the opening 602. As illustrated in FIG. 13, a width x2 in the X-axis direction when the position in the Z-axis direction is a position z2 is longer than a width x1 in the X-axis direction when the position in the Z-axis direction is a position z1. The position z2 is located further in the −Z direction than is the position z1. The amount of increase Δx1 in width in the X-axis direction at the position z1 is larger than the amount of increase Δx2 in width in the X-axis direction at the position z2. The amount of increase Δx1 and the amount of increase Δx2 are amounts of increase in width in the X-axis direction with respect to a minute amount Δz in the Z-axis direction. The position z1 and the position z2 are freely selected positions in the Z-axis direction in the second nozzle portion NP2. The minute amount Δz may be any length, but is preferably, for example, approximately 5% or more and 15% or less of a width LZ2 of the second nozzle portion NP2 in the Z-axis direction.

As illustrated in FIG. 14, the width of the first nozzle portion NP1 in the Y-axis direction is constant regardless of the position in the Z-axis direction. The width of the first nozzle portion NP1 in the Y-axis direction is twice the radius R1. A minimum width of the second nozzle portion NP2 in the Y-axis direction is twice the radius R1. A longest width of the second nozzle portion NP2 in the Y-axis direction is twice the radius R2. As illustrated in FIG. 14, a width y2 in the Y-axis direction at the position z2 is longer than a width y1 in the Y-axis direction at the position z1. The amount of increase Δy1 in width in the Y-axis direction at the position z1 is larger than the amount of increase Δy2 in width in the Y-axis direction at the position z2.

As illustrated in FIG. 13, when viewed in the +Y direction, the wall surface SF2 of the nozzle substrate 60 that defines the second nozzle portion NP2 has a curved shape. Specifically, a contour of the wall surface SF2 when viewed in the +Y direction is an arc. Similarly, as illustrated in FIG. 14, when viewed in the +X direction, the wall surface SF2 of the nozzle substrate 60 that defines the second nozzle portion NP2 has a curved shape. Specifically, a contour of the wall surface SF2 when viewed from the +X direction is an arc. That is, the wall surface SF2 is formed by hollowing out the surface FN2 in a substantially hemispherical shape. A curvature of the wall surface SF2 is constant. However, the curvature of the wall surface SF2 does not have to be constant.

As is understood from FIG. 13, at the connection position SP, the width of the first nozzle portion NP1 in the Z-axis direction and the width of the second nozzle portion NP2 in the Z-axis direction are equal to each other. In other words, it can be said that a plane parallel to the XY plane is not present at the connection position SP. A case where two widths are equal to each other includes not only a case where the two widths are completely equal to each other but also a case where the two widths can be regarded as equal to each other in consideration of an error.

As illustrated in FIG. 13, at the connection position SP, an angle θ1 is included in a range of 180 degrees or more and 270 degrees or less. The angle θ1 is an angle on the nozzle N side of the angles formed by the first nozzle portion NP1 and the second nozzle portion NP2. Specifically, the angle θ1 is an angle of 180 degrees or more of the angles formed by a wall surface SF1 of the first nozzle portion NP1 and a tangent TL1 at the connection position SP of the second nozzle portion NP2 in a cross section parallel to an XZ plane and passing through the nozzle central axis AZ. The angle θ1 is an example of a “first angle”.

The angle θ1 is preferably included in a range of 217 degrees or more and 270 degrees or less, and more preferably included in a range of 250 degrees or more and 270 degrees or less. The angle θ1 is, for example, 253 degrees. It can also be said that the angle θ1 is an angle obtained by adding an angle θ3 to 180 degrees. The angle θ3 is an angle of the tangent TL1 with respect to the Z-axis. The angle θ3 is, for example, 73 degrees. The angle θ1 is preferably larger than an angle obtained by adding an angle 04 to 180 degrees. The angle θ4 is an angle of a virtual line segment LV1 with respect to the Z-axis direction in a cross section parallel to the XZ plane and passing through the nozzle central axis AZ. The virtual line segment LV1 is a line segment connecting the connection position SP of the second nozzle portion NP2 to a connection position SQ between the second nozzle portion NP2 and the opening 602. The angle θ4 is obtained, for example, as follows.

$$θ4 = arctan ( ( R 2 - R 1 ) / LZ 2 )$$

However, arctan ( ) is the inverse function of the tangent function.

As illustrated in FIG. 13, an angle θ2 is included in a range of 180 degrees or more and 270 degrees or less. The angle θ2 is an angle on the nozzle N side of the angles formed by the second nozzle portion NP2 and the surface FN2. Specifically, the angle θ2 is an angle of 180 degrees or more of the angles formed by the surface FN2 and a tangent TL2 of the opening 602 portion of the second nozzle portion NP2 in a cross section parallel to the XZ plane and passing through the nozzle central axis ΔZ. The angle θ2 is preferably larger than the angle θ1. The angle θ2 is preferably larger than an angle obtained by adding an angle θ5 to 180 degrees. The angle θ5 is an angle obtained by subtracting the angle θ4 from 90 degrees. The angle θ2 is an example of a “second angle”.

As illustrated in FIGS. 13 and 14, a width LZ1 of the first nozzle portion NP1 in the Z-axis direction is shorter than the width LZ2.

### A6. Summary of First Embodiment

As described above, the liquid ejecting heads 1 according to the first embodiment includes the pressure chamber substrate 3 and the communication plate 2, which are provided with the circulation flow paths RJ; the nozzle substrate 60 provided with the nozzles N causing the circulation flow paths RJ to communicate with the outside and passing through the nozzle substrate 60 from the surface FN1 to the surface FN2, the surface FN2 being bonded to the communication plate 2; and the piezoelectric elements PZq that generate energy for ejecting ink from the nozzles N. When a direction in which the communication plate 2 and the nozzle substrate 60 are stacked is defined as the Z-axis direction and a direction orthogonal to the Z-axis direction is defined as the X-axis direction, the nozzles N include the first nozzle portion NP1 passing from the surface FN1 to the connection position SP in the nozzle substrate 60 and the second nozzle portion NP2 that is a hole passing from the connection position SP to the surface FN2. The first nozzle portion NP1 has a constant width in the X-axis direction regardless of the position in the Z-axis direction. The second nozzle portion NP2 has a width in the X-axis direction that gradually increases such that the amount of increase in width in the X-axis direction decreases as the position in the Z-axis direction approaches the surface FN2.

According to the first embodiment, by making the inclination of the wall surface SF2 steep in the upper portion of the second nozzle portion NP2 and making the inclination of the wall surface SF2 gentle in the lower portion of the second nozzle portion NP2 in the X-axis direction, it is possible to suppress breakage of the meniscus MN compared to the nozzle NB, which is the second reference example. Since it is possible to suppress the breakage of the meniscus MN, it is possible to suppress mixing of a bubble into the nozzles N.

In addition, at the connection position SP, the width of the first nozzle portion NP1 in the Z-axis direction is equal to the width of the second nozzle portion NP2 in the Z-axis direction.

In a nozzle in which a surface parallel to the XY plane is present at the connection position SP, stagnation of ink may occur on the parallel surface, and ink whose viscosity is increased may be retained. Therefore, according to the first embodiment, it is possible to suppress retention of a bubble compared to the nozzle in which a surface parallel to the XY plane is present at the connection position SP.

In addition, when the second nozzle portion NP2 is viewed in the Y-axis direction, which is orthogonal to the Z-axis direction and the X-axis direction, the wall surface SF2 of the nozzle substrate 60, which defines the second nozzle portion NP2, has a curved shape.

According to the first embodiment, it is possible to make the flow inside the nozzles N smooth compared to an aspect in which the wall surface SF2 has a bent line shape.

In addition, at the connection position SP, the angle θ1 is included in a range of 180 degrees or more and 270 degrees or less. Further, at the connection position SP, the angle θ1 is preferably included in a range of 217 degrees or more and 270 degrees or less, and more preferably included in a range of 250 degrees or more and 270 degrees or less.

In addition, the angle θ2 is included in a range of 180 degrees or more and 270 degrees or less. Further, the angle θ2 is preferably larger than the angle θ1. When the above-described ranges are combined, it is preferable that the angle θ1 is 250 degrees or more and smaller than the angle θ2. Since the angle θ2 is larger than the angle θ1, the inclination of the wall surface SF2 becomes steep at an end portion of the second nozzle portion NP2 in the −Z direction compared to an aspect in which the angle θ1 is larger than the angle θ2. Therefore, it is possible to suppress an excessive pressure being transmitted toward the first nozzle portion NP1 of the nozzle NB. In addition, in an aspect in which the angle θ1 is larger than the angle θ2, for example, in an aspect in which the angle θ1 is extremely close to 270 degrees, a region that is not strictly horizontal with respect to the XY plane but can be considered to be substantially horizontal is generated in the vicinity of the connection position SP of the second nozzle portion NP2, stagnation of ink may occur in the region that can be considered to be horizontal, and ink whose viscosity is increased may be retained. As described above, according to the first embodiment, compared to an aspect in which the angle θ1 is larger than the angle θ2, it is possible to suppress the retention of the ink whose viscosity is increased while suppressing an excessive pressure being transmitted toward the first nozzle portion NP1 of the nozzle NB.

In addition, the width of the first nozzle portion NP1 in the Y-axis direction is constant regardless of the position in the Z-axis direction, and the width of the second nozzle portion NP2 in the Y-axis direction gradually increases such that the amount of increase in width in the Y-axis direction decreases as the position in the Z-axis direction approaches the surface FN2.

According to the first embodiment, in the Y-axis direction, by making the inclination steep in the upper portion of the second nozzle portion NP2 and making the inclination gentle in the lower portion of the second nozzle portion NP2, it is possible to suppress breakage of the meniscus MN and to suppress mixing of a bubble, compared to the nozzle NB, which is the second reference example.

In addition, the width LZ1 of the first nozzle portion NP1 in the Z-axis direction is shorter than the width LZ2 of the second nozzle portion NP2 in the Z-axis direction.

By shortening the width LZ1, resistance applied to the ink is reduced. Therefore, when the ink has a high viscosity, it is preferable to shorten the width LZ1. However, when the width LZ1 is shortened, the meniscus MN easily reaches the second nozzle portion NP2. Therefore, even when the ink has a high viscosity, the nozzles N according to the first embodiment can suppress breakage of the meniscus MN.

### B. Second Embodiment

The shape of the nozzles N is not limited to that of the nozzles N illustrated in the first embodiment. A second embodiment will be described below.

FIG. 15 is a view for explaining a nozzle NC in the second embodiment. FIG. 15 illustrates a cross section of the nozzle NC taken along line XV-XV in FIG. 12. The nozzle NC is different from the nozzles N in that the nozzle NC has a second nozzle portion NPC2 instead of the second nozzle portion NP2.

Similarly to the second nozzle portion NP2, as the position in the Z-axis direction approaches the surface FN2, the width of the second nozzle portion NPC2 in the X-axis direction gradually increases such that the amount of increase in width in the X-axis direction decreases. In other words, the inclination of a wall surface SFC2 is gentle in a lower portion of the second nozzle portion NPC2, and the inclination of the wall surface SFC2 becomes steeper toward an upper portion of the second nozzle portion NPC2. However, in the second embodiment, the ratio of a radius RC2 of an opening 602C to the radius R1 of the opening 601 is smaller than the ratio of the radius R2 of the opening 602 to the radius R1 of the opening 601. As illustrated in FIG. 15, a width xC2 in the X-axis direction when the position in the Z-axis direction is the position z2 is longer than a width xC1 in the X-axis direction when the position in the Z-axis direction is the position z1. The amount of increase ΔxC1 in width in the X-axis direction at the position z1 is larger than the amount of increase ΔxC2 in width in the X-axis direction at the position z2.

Although not illustrated, the width in the Y-axis direction at the position z2 is longer than the width in the Y-axis direction at the position z1. The amount of increase in width in the Y-axis direction at the position z1 is larger than the amount of increase in width in the Y-axis direction at the position z2.

As illustrated in FIG. 15, at the connection position SP, an angle θC1 is included in a range of 180 degrees or more and 270 degrees or less. The angle θC1 is an angle on the nozzle N side of the angles formed by the first nozzle portion NP1 and the second nozzle portion NPC2. Specifically, the angle θC1 is an angle of 180 degrees or more of the angles formed by the wall surface SF1 and a tangent TLC1 at the connection position SP of the second nozzle portion NPC2 in a cross section parallel to the XZ plane and passing through the nozzle central axis ΔZ. In the second embodiment, the angle θC1 is an example of a “first angle”.

Similarly to the angle θ1, the angle θC1 is preferably included in a range of 217 degrees or more and 270 degrees or less, and more preferably included in a range of 250 degrees or more and 270 degrees or less. The angle θC1 is, for example, 217 degrees. It can also be said that the angle θC1 is an angle obtained by adding an angle θC3 to 180 degrees. The angle θC3 is an angle of the tangent TLC1 with respect to the Z-axis. The angle θC3 is, for example, 37 degrees.

As illustrated in FIG. 15, an angle θC2 is included in a range of 180 degrees or more and 270 degrees or less. The angle θC2 is an angle on the nozzle N side of the angles formed by the second nozzle portion NPC2 and the surface FN2. Specifically, the angle θC2 is an angle of 180 degrees or more of the angles formed by the surface FN2 and a tangent TLC2 of the opening 602 portion of the second nozzle portion NPC2 in a cross section parallel to the XZ plane and passing through the nozzle central axis ΔZ. The angle θC2 is preferably larger than the angle θC1. In the second embodiment, the angle θC2 is an example of a “second angle”.

### C. Modifications

Each of the above-described embodiments can be variously modified. Specific modifications that can be applied to each of the above-described embodiments will be described below. Two or more aspects freely selected from the following examples can be appropriately combined within a range in which the two or more aspects do not contradict each other.

### C1. First Modification

In each of the above-described aspects, the width LZ1 of the first nozzle portion NP1 in the Z-axis direction is shorter than the width LZ2 of the second nozzle portion NP2 in the Z-axis direction, but the present disclosure is not limited to this. Hereinafter, a first modification will be described.

FIG. 16 is a view for explaining a nozzle ND in the first modification. FIG. 16 illustrates a cross section of the nozzle ND taken along line XVI-XVI in FIG. 12. The nozzle ND is different from the nozzles N in that the nozzle ND has a first nozzle portion NPD1 instead of the first nozzle portion NP1 and has a second nozzle portion NPD2 instead of the second nozzle portion NP2. A width LZD1 of the first nozzle portion NPD1 in the Z-axis direction is longer than a width LZD2 of the second nozzle portion NPD2 in the Z-axis direction.

The nozzle ND is particularly effective, for example, when the nozzle substrate 60 is thin, or when ink has a high viscosity and the diameter of the second nozzle portion NPD2 is desired to be large.

### C2. Second Modification

In each aspect described above, the pressure chamber substrate 3 and the communication plate 2 are separate bodies, but may be an integrated flow path substrate.

### C3. Third Modification

In each aspect described above, the nozzles N are in communication with the nozzle flow paths RN, but the present disclosure is not limited to this. For example, the nozzles N may be located in the +Z direction of the communication flow paths RR1 in the nozzle substrate 60. Alternatively, the circulation flow paths RJ do not have to include the communication flow paths RR1, and the nozzles N may be located at openings of the pressure chambers CB1 in the −X direction.

### C4. Fourth Modification

In each aspect described above, the piezoelectric element PZq is an example of the “energy generation element”, but the present disclosure is not limited to this. The energy generation element may be a heating element that converts electric energy into thermal energy, generates a bubble inside the pressure chamber CBq by heating, and changes the pressure inside the pressure chamber CBq.

### C5. Fifth Modification

In each aspect described above, a serial type liquid ejecting apparatus in which the storage case 921 that stores the liquid ejecting heads 1 reciprocates is exemplified, but the present disclosure can also be applied to a line type liquid ejecting apparatus in which the plurality of nozzles N is distributed over the entire width of the medium PP.

### C6. Sixth Modification

The liquid ejecting apparatus 100 exemplified in each aspect described above can be adopted in various apparatuses such as a facsimile apparatus and a copy machine in addition to an apparatus dedicated to printing. However, the application of the liquid ejecting apparatus is not limited to printing. For example, a liquid ejecting apparatus that ejects a solution of a coloring material is used as a manufacturing apparatus that forms a color filter of a display device such as a liquid crystal display panel. In addition, a liquid ejecting apparatus that ejects a solution of a conductive material is used as a manufacturing apparatus that forms wiring or an electrode of a wiring substrate. In addition, a liquid ejecting apparatus that ejects a solution of an organic substance related to a living body is used as a manufacturing apparatus that manufactures a biochip, for example.

What is claimed is:

1. A liquid ejecting head comprising:
a flow path substrate provided with a flow path;
a nozzle substrate provided with a nozzle causing the flow path to communicate with an outside and passing through the nozzle substrate from a first surface to a second surface of the nozzle substrate, the second surface being bonded to the flow path substrate; and
an energy generation element that generates energy for ejecting a liquid from the nozzle, wherein
when a direction in which the flow path substrate and the nozzle substrate are stacked is defined as a first direction, and
a direction orthogonal to the first direction is defined as a second direction,
the nozzle includes a first nozzle portion passing from the first surface to a connection position in the nozzle substrate and a second nozzle portion that is a hole passing from the connection position to the second surface,
the first nozzle portion has a constant width in the second direction regardless of a position in the first direction, and
the second nozzle portion has a width in the second direction that gradually increases such that an amount of increase in width in the second direction decreases as a position in the first direction approaches the second surface.

2. The liquid ejecting head according to claim 1, wherein
at the connection position, a width of the first nozzle portion in the first direction is equal to a width of the second nozzle portion in the first direction.

3. The liquid ejecting head according to claim 1, wherein
when the second nozzle portion is viewed in a third direction orthogonal to the first direction and the second direction, a wall surface of the nozzle substrate that defines the second nozzle portion has a curved shape.

4. The liquid ejecting head according to claim 1, wherein
at the connection position, a first angle, as an angle on the nozzle side of angles formed by the first nozzle portion and the second nozzle portion, is included in a range of 180 degrees or more and 270 degrees or less.

5. The liquid ejecting head according to claim 4, wherein
at the connection position, the first angle is included in a range of 217 degrees or more and 270 degrees or less.

6. The liquid ejecting head according to claim 5, wherein
at the connection position, the first angle is included in a range of 250 degrees or more and 270 degrees or less.

7. The liquid ejecting head according to claim 4, wherein
a second angle, as an angle on the nozzle side of angles formed by the second nozzle portion and the second surface, is included in a range of 180 degrees or more and 270 degrees or less.

8. The liquid ejecting head according to claim 7, wherein
the second angle is larger than the first angle.

9. The liquid ejecting head according to claim 1, wherein
when a direction orthogonal to the first direction and the second direction is defined as a third direction,
the first nozzle portion has a constant width in the third direction regardless of a position in the first direction, and
the second nozzle portion has a width in the third direction that gradually increases such that an amount of increase in width in the third direction decreases as a position in the first direction approaches the second surface.

10. The liquid ejecting head according to claim 1, wherein
a width of the first nozzle portion in the first direction is shorter than a width of the second nozzle portion in the first direction.
